(19) United States
(12) Patent Application Publication
(10) Pub. No.: US 2026/0016877 A1
(43) Pub. Date: Jan. 15, 2026

(54) MICRO-CONTROLLER SYSTEM AND METHOD FOR WAKING UP THE CENTRAL PROCESSING UNIT

(71) Applicant: Nuvoton Technology Corporation, Hsinchu Science Park (TW)

(72) Inventor: Chi-Ray HUANG, Kaohsiung City (TW)

(21) Appl. No.: 19/226,457

(22) Filed: Jun. 3, 2025

(30) Foreign Application Priority Data
Jul. 10, 2024 (TW) 113125806

(51) Int. Cl. G06F 1/3215; G06F 13/32

(52) U.S. Cl. CPC G06F 1/3215; G06F 13/32

(57) ABSTRACT

A micro-controller system including a central processing unit, a peripheral device, and an interrupt pre-processor is provided. The interrupt pre-processor is connected between the central processing unit and the peripheral device. When the central processing unit is powered down, the interrupt pre-processor is configured to receive an interrupt signal from the peripheral device and output a wake-up signal to activate the central processing unit when the number of times that the interrupt pre-processor receives the interrupt signal from the peripheral device is higher than or equal to the first predetermined number.

### CROSS REFERENCE TO RELATED APPLICATIONS

This application claims priority of Taiwan Patent Application No. 113125806, filed on Jul. 10, 2024, the entirety of which is incorporated by reference herein.

### BACKGROUND OF THE INVENTION

### Field of the Invention

The present invention relates to micro-controller systems, and, in particular, it relates to methods for waking up the central processing unit in a micro-controller system.

### Description of the Related Art

To save power, electronic devices may be configured to enter a low power mode (low power consumption mode). In the low power mode, the components in the high-performance domain of the electronic device are powered down, and the components in the low power domain of the electronic device keep working to perform certain tasks. When the components in the low power domain complete a task, the components in the low power domain wake up the central processing unit in the high-performance domain, so as to obtain data required to complete other tasks from the central processing unit.

However, if every component in the low power domain wakes up the central processing unit whenever it completes a task, the central processing unit will be woken up frequently. This will cause power consumption to be high. Thus, a method for waking up the central processing unit is required to solve the aforementioned issue.

### BRIEF SUMMARY OF THE INVENTION

Embodiments of the present disclosure provide a micro-controller system, which comprises a central processing unit, a peripheral device, and an interrupt pre-processor. The interrupt pre-processor is connected between the central processing unit and the peripheral device. When the central processing unit is powered down, the interrupt pre-processor is configured to receive an interrupt signal from the peripheral device and output a wake-up signal to activate the central processing unit when the number of times that the interrupt pre-processor receives the interrupt signal from the peripheral device is higher than or equal to a first predetermined number.

In some embodiments, the interrupt pre-processor is further configured to receive temperature information from the peripheral device and output the wake-up signal to activate the central processing unit when the number of times that the temperature information is higher than a threshold is higher than or equal to the second predetermined number. In some embodiments, the first predetermined number is higher than or equal to 2. In some embodiments, the interrupt pre-processor is further configured to control a peripheral direct memory access device to read data in a memory and to transmit the data to the peripheral device when the number of times that the interrupt pre-processor receives the interrupt signal from the peripheral device is lower than the first predetermined number. In some embodiments, the peripheral direct memory access device is further configured to read the data corresponding to the number of times and the peripheral device, and then to transmit the data to the peripheral device.

Embodiments of the present disclosure provide a method for waking up the central processing unit, applicable to a micro-controller system comprising a central processing unit, a peripheral device, and an interrupt pre-processor. The interrupt pre-processor is connected between the central processing unit and the peripheral device. The method comprises receiving an interrupt signal from the peripheral device using the interrupt pre-processor when the central processing unit is powered down and outputting a wake-up signal to activate the central processing unit using the interrupt pre-processor when the number of times that the interrupt pre-processor receives the interrupt signal from the peripheral device is higher than or equal to the first predetermined number.

### BRIEF DESCRIPTION OF THE DRAWINGS

The present invention can be more fully understood by reading the subsequent detailed description and examples with references made to the accompanying drawings, wherein:

FIG. 1 is a block diagram of the micro-controller system in accordance with the embodiments of the present disclosure;

FIG. 2 is a block diagram of the micro-controller system in accordance with the embodiments of the present disclosure;

FIG. 3 is a schematic diagram of the embodiments of the present disclosure; and

FIG. 4 is a flow diagram of the method for waking up the central processing unit in accordance with the embodiments of the present disclosure.

### DETAILED DESCRIPTION OF THE INVENTION

The following description is made for the purpose of illustrating the general principles of the invention and should not be taken in a limiting sense. The scope of the invention is best determined by reference to the appended claims.

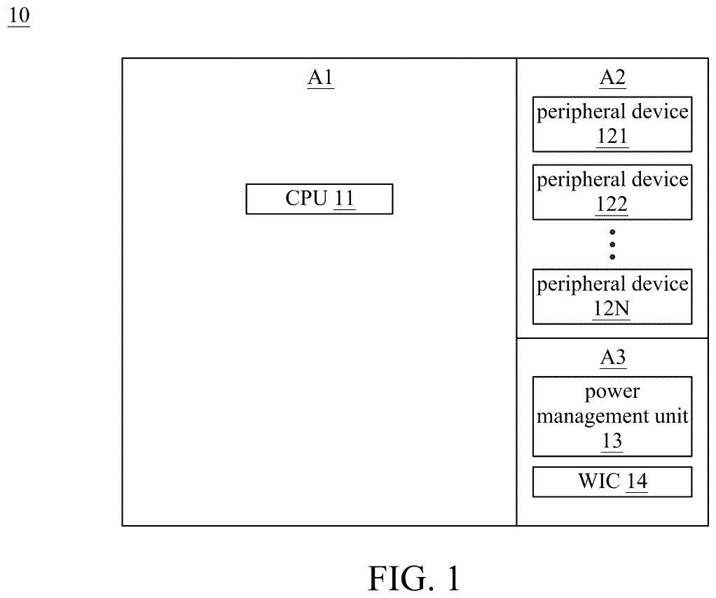

Refer to FIG. 1. FIG. 1 is a block diagram of the micro-controller system 10 in accordance with the embodiments of the present disclosure. As shown in FIG. 1, the micro-controller system 10 comprises a high-performance domain A1, a low power domain A2, and an always-on domain A3.

The components in the high-performance domain A1 are configured to perform important, real-time programs and complicated computing operations in a high speed. The components in the high-performance domain A1 have higher power consumptions. Thus, when the micro-controller system 10 enters the low power mode (e.g. power-down mode, sleep mode, or power-saving mode), the components in the high-performance domain A1 are powered down or turned off in order to reduce the leakage current power consumption. The high-performance domain A1 comprises a central process unit (CPU). Furthermore, the high-performance domain A1 may further comprise other components which are not shown in FIG. 1, such as the flash memory, the static random access memory (SRAM), the cache RAM, the SRAM controller, the flash controller, the cache controller, the clock controller, the general-purpose input/output (GPIO), the high speed internal resistor capacitor (RC) oscillator (HIRC), the middle speed internal RC oscillator (MIRC), and the global miscellaneous control register (GMISC).

On the other hand, the components in the low power domain A2 have low power consumption, simple functionality, and slow operation speeds. In some embodiments, the frequency of the clock of the components in the low power domain A2 are lower than the frequency of the clock of the components in the high-performance domain A1. For example, the frequency of the clock of the components in the low power domain A2 are half of the frequency of the clock of the components in the high-performance domain A1. When the micro-controller system 10 enters the low power mode, the components in the low power domain A2 aren't powered down. The low power domain A2 comprises peripheral devices 121˜12N. The low power domain A2 may comprise any number of peripheral devices 121˜12N. In other words, N may be any positive integer. For example, the peripheral devices 121˜12N may be timer, analog-to-digital converter, digital-to-analog converter, operational amplifier, inter-integrated circuit (I2C) bus, universal asynchronous receiver/transmitter (UART), serial peripheral interface (SPI) bus, sensor, and Pulse-width modulation (PWM) signal generator.

When the micro-controller system 10 enters the low power mode, the components in the always-on domain A3 aren't powered down. The always-on domain A3 comprises the power management unit 13 and wake-up and interrupt controller (WIC) 14. The power management unit 13 is configured to manage the power of the micro-controller system 10. The WIC 14 is configured to activate the powered-down CPU 11.

In the low power mode, the peripheral devices 121˜12N perform one or more tasks, such as calculation or data collection. After the peripheral device 121 completed the task, the peripheral device 121 outputs the interrupt signal in order to activate the CPU 11. Specifically, the peripheral device 121 outputs the interrupt signal to the WIC 14, and the WIC 14 notifies the power management unit 13 to activate the CPU 11. After activated, the CPU 11 receives data (e.g. the calculation results or the collected data) from the peripheral device 121. After that, the CPU 11 provides data to the peripheral device 121. For example, the CPU 11 may assign new task to the peripheral device 121 and/or provide the parameters required to perform the new task to the peripheral device 121. Thus, the peripheral device 121 can continue to perform tasks. Similarly, the peripheral devices 122˜12N also activate the CPU 11 to obtain the required data the peripheral devices 122˜12N completed the task. However, waking up the CPU 11 after completing a task for each of the peripheral devices 121˜12N will result in higher power consumption.

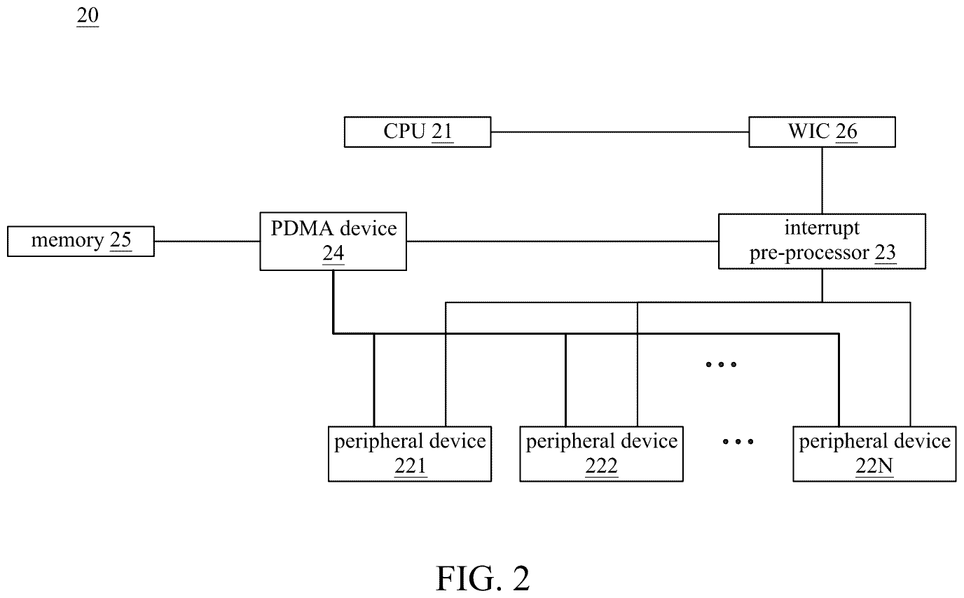

FIG. 2 illustrates a micro-controller system which is able to reduce the power consumption. Refer to FIG. 2. FIG. 2 is a block diagram of the micro-controller system 20 in accordance with the embodiments of the present disclosure. The micro-controller system 20 comprises CPU 21, peripheral devices 221˜22N, the interrupt pre-processor 23, peripheral direct memory access (PDMA) device 24, memory 25, and WIC 26. In some embodiments, the micro-controller system 20 may be implemented in the electronic device, such as desktop computer, laptop computer, tablet computer, or smartphone. CPU 21 is similar to CPU 11, peripheral devices 221˜22N are similar to peripheral devices 121˜12N, and the WIC 26 is similar to the WIC 14. The description of these components can refer to the above description. In some embodiments, the CPU 21 is in the high-performance domain A1, the peripheral devices 221-22N are in the low power domain A2, and the WIC 26 is in the always-on domain A3. The low power domain A2 may comprise any number of peripheral devices 221˜22N. In other words, N may be any positive integer.

The interrupt pre-processor 23 is connected between the peripheral devices 221˜22N and the CPU 21 (the interrupt pre-processor 23 connects the peripheral devices 221˜22N to the CPU 21). The interrupt pre-processor 23 is configured to determine whether to activate (wake-up) the CPU 21. In some embodiments, the interrupt pre-processor 23 comprises at least one counter, at least one comparator, and/or at least one register.

The PDMA device 24 is configured to read and transmit data. In some embodiments, the PDMA device 24 doesn't have computing power. The PDMA device 24 only have the ability to move data. For example, the PDMA device 24 is only configured to read the data from the memory 25 and transmit the read data to the peripheral devices 221˜22N.

The memory 25 is configured to store the data required by the peripheral devices 221-22N to perform the task and other data. For example, the memory 25 stores parameters or values related to the task. In some embodiments, the memory 25 is the low power static random access memory (LPSRAM)

After the CPU 21 is powered down, the interrupt pre-processor 23 receives signals from the peripheral devices 221˜22N and determines whether to activates the CPU 21 based on the signals and the predetermined condition.

In some embodiments, the interrupt pre-processor 23 receives interrupt signals from the peripheral devices 221˜22N. When the number of times that the interrupt pre-processor 23 receives interrupt signals from the peripheral devices 221˜22N is higher than or equal to the first predetermined number, the interrupt pre-processor 23 outputs the wake-up signal (e.g. the interrupt_final signal) to activate the CPU 21. In some embodiments, the interrupt pre-processor 23 outputs the wake-up signal to the WIC 26, and the WIC 26 activates the CPU 21 after receiving the wake-up signal. When the number of times that the interrupt pre-processor 23 receives interrupt signals from the peripheral devices 221˜22N is lower than the first predetermined number, the interrupt pre-processor 23 doesn't output the wake-up signal, and the CPU 21 stays powered down. In other words, when the total number of times that all the peripheral devices 221˜22N transmit the interrupt signal is larger than or equal to the first predetermined number, the interrupt pre-processor 23 activates the CPU 21. In some embodiments, the total number of times is counted from 0 after the CPU 21 is powered off.

In other embodiments, the signal received using the interrupt pre-processor 23 from the peripheral devices 221˜22N comprises temperature information. The interrupt pre-processor 23 determines whether temperature information (i.e. the temperature) is higher than the threshold. When the number of times that the temperature information is higher than the threshold is higher than or equal to the second predetermined number, the interrupt pre-processor 23 outputs the wake-up signal to activate the CPU 21. When the number of times that the temperature information is higher than the threshold is lower than the second predetermined number, the interrupt pre-processor 23 doesn't output the wake-up signal, and the CPU 21 stays powered down. In other words, when the total number of times that the temperature information reported from the peripheral devices 221˜22N is higher than the threshold is higher than or equal to the second predetermined number, the interrupt pre-processor 23 activates the CPU 21. In some embodiments, the total number of times is counted from 0 after the CPU 21 is powered off.

Thus, the predetermined condition is, for example, “the number of times that the interrupt pre-processor 23 receives the interrupt signal from the peripheral devices 221˜22N is higher than or equal to the first predetermined number” or “the number of times that the temperature information is higher than the threshold is higher than or equal to the second predetermined number”. The CPU 21 can determine to be waked-up “when the number of times that the peripheral devices 221-22N output the interrupt signal is the first predetermined number” or “when the number of times that the temperature information is higher than the threshold is the second predetermined number”. In some embodiments, the first predetermined number and the second predetermined number are determined via the CPU 21 before the CPU 21 is powered down. In some embodiments, the first predetermined number and the second predetermined number are integers higher than or equal to 2. Thus, the CPU 21 won't be waked-up whenever the peripheral devices 221˜22N output the interrupt signal. Instead, the CPU 21 will be waked-up after the peripheral devices 221˜22N have completed a plurality of tasks. Furthermore, the function and the structure of the interrupt pre-processor 23 is simpler compared to the CPU 21. Thus, the micro-controller system 20 can reduce the power consumption.

The following description takes the situation that the peripheral device 221 outputs the interrupt signal as example to illustrate the operation of the interrupt pre-processor 23, the PDMA device 24, and the memory 25. When the number of times that the interrupt pre-processor 23 receives the interrupt signal from the peripheral devices 221˜22N is lower than the first predetermined number (or when the number of times that the temperature information is higher than the threshold is lower than the second predetermined number), the interrupt pre-processor 23 controls the PDMA device 24 to read the data in the memory 25 and to transmit the data to the peripheral device 221 (i.e. the device which outputs the interrupt signal). The PDMA device 24 is configured to read the data corresponding to the number of times that the peripheral device 221 outputs the interrupt signal and corresponding to the peripheral device 221 in the memory 25. In some embodiments, the data is the parameters required by the peripheral device 121 to perform the task.

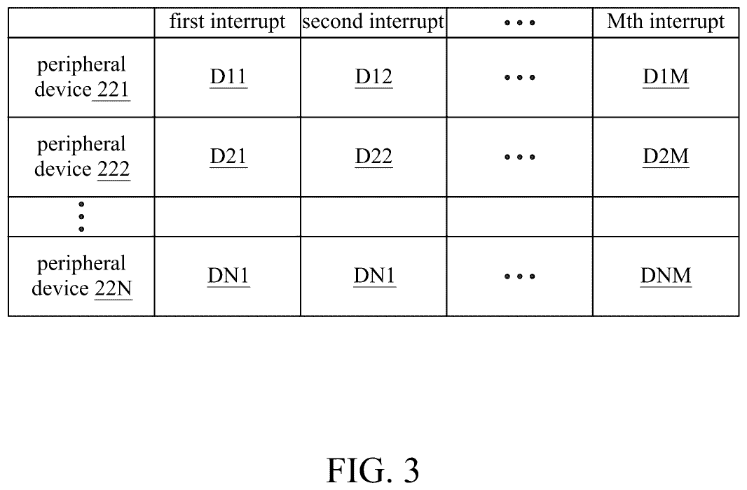

The memory 25 may comprise the data storage structure shown in FIG. 3. The data D11˜D1M stored in the different locations of the memory 25 corresponds to different peripheral devices 221˜22N and to the number of times that the peripheral devices 221˜22N output the interrupt signals. For example, data D11 corresponds to the first interrupt signal output via the peripheral device 221, data D1M corresponds to the Mth interrupt signal output via the peripheral device 221, data D22 corresponds to the second interrupt signal output via the peripheral device 222, and so on. When the interrupt pre-processor 23 receives the interrupt signal from the peripheral device 221 for the first time, the interrupt pre-processor 23 controls the PDMA device 24 to read data D11 and to transmit data D11 to the peripheral device 221. When the interrupt pre-processor 23 receives the interrupt signal from the peripheral device 221 for the Mth time, the interrupt pre-processor 23 controls the PDMA device 24 to read data D1M and to transmit data D1M to the peripheral device 221.

In some embodiments, after the interrupt pre-processor 23 receives the interrupt signal from the peripheral device, the interrupt pre-processor 23 transmits an impulse to the PDMA device 24. The pulse indicates which peripheral device outputs the interrupt signal. In some embodiments, the impulse may comprise the identification information of the peripheral device which outputs the interrupt signal. The PDMA device 24 reads the corresponding data in the memory 25 based on the identification information and the number of times that the PDMA device 24 receives the impulse comprising the said identification information. For example, when the PDMA device 24 receives the impulse indicating the peripheral device 221 for the first time, the PDMA device 24 reads the data D11 and transmits the data D11 to the peripheral device 221. When the PDMA device 24 receives the impulse indicating the peripheral device 22N for the Mth time, the PDMA device 24 reads the data DNM and transmits the data DNM to the peripheral device 22N.

In some embodiments, the interrupt pre-processor 23 and the PDMA device 24 connects to each other via the bus. After the interrupt pre-processor 23 receives the interrupt signal from the peripheral device, the interrupt pre-processor 23 informs the PDMA device 24 the identification information of the peripheral device which outputs the interrupt signal and the number of times that the said peripheral device outputs the interrupt signal. The PDMA device 24 reads the corresponding data in the memory 25 based on and the number of times that the peripheral device outputs the interrupt signal and the identification information. In this way, the PDMA device 24 doesn't have to store the number of times that each of the peripheral devices transmits the interrupt signal.

In some embodiments, the CPU 21 assigns tasks to the peripheral devices 221˜22N and writes data D11˜DNM to the memory 25 before the CPU 21 is powered down. Thus, the peripheral devices 221˜22N can still obtain the data required for different tasks via the interrupt pre-processor 23 and the PDMA device 24, even the CPU 21 is powered down. The micro-controller system 20 allows the peripheral devices 221˜22N to perform tasks without waking up the CPU 21 while the CPU 21 is powered down. Furthermore, because the PDMA device 24 doesn't have complex computing capabilities, comparing to allocating data using CPU 21, moving data using the PDMA device 24 has lower power consumption. Thus, the micro-controller system 20 can reduce the power consumption.

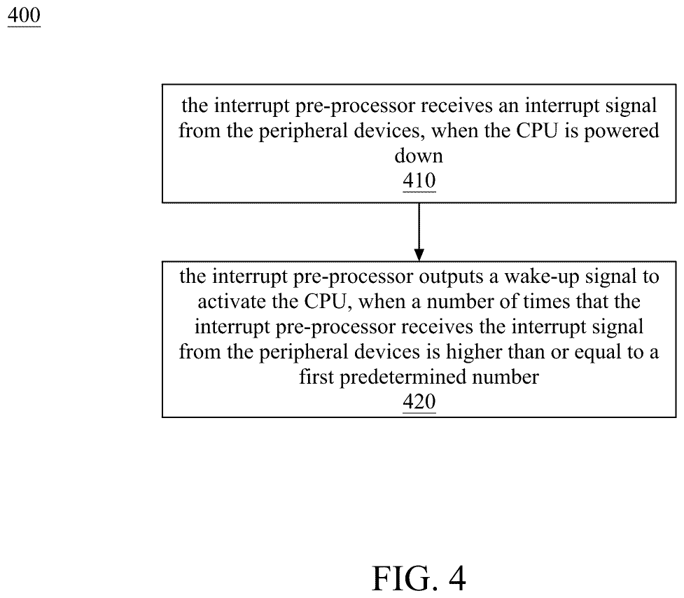

Refer to FIG. 4. FIG. 4 is a flow diagram of the method 400 for waking up the central processing unit in accordance with the embodiments of the present disclosure. Method 400 is applicable to the micro-controller system 20 and can be implemented in the micro-controller system 20. In step 410, the interrupt pre-processor 23 receives an interrupt signal from the peripheral devices 221˜22N, when the CPU 21 is powered down. In step 420, the interrupt pre-processor 23 outputs a wake-up signal to activate the CPU 21, when the number of times that the interrupt pre-processor 23 receives the interrupt signal from the peripheral devices 221˜22N is higher than or equal to the first predetermined number. Furthermore, the interrupt pre-processor 23 controls the PDMA device 24 to read data in a memory 25 and to transmit the data to the peripheral devices 221-22N, when the number of times that the interrupt pre-processor 23 receives the interrupt signal from the peripheral devices 221˜22N is lower than the first predetermined number.

Above embodiments are described or illustrated using a series of operations or events. However it should be understood that the order in which the operations or events are described should not be the limitation. For example, some operations may be happened in different order, or some operations or events described herein may be removed within reasonable limits. Moreover, one or more operations described herein may be performed in one or more separate operations and/or phases.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A micro-controller system, comprising:
a central processing unit;
a peripheral device; and
an interrupt pre-processor, connected between the central processing unit and the peripheral device;
wherein when the central processing unit is powered down, the interrupt pre-processor is configured to:
receive an interrupt signal from the peripheral device; and
output a wake-up signal to activate the central processing unit, when a number of times that the interrupt pre-processor receives the interrupt signal from the peripheral device is higher than or equal to a first predetermined number.

2. The micro-controller system as claimed in claim 1, wherein the interrupt pre-processor is further configured to:
receive a temperature information from the peripheral device; and
output the wake-up signal to activate the central processing unit when a number of times that the temperature information is higher than a threshold is higher than or equal to a second predetermined number.

3. The micro-controller system claimed in claim 1, wherein the first predetermined number is higher than or equal to 2.

4. The micro-controller system as claimed in claim 1, wherein the interrupt pre-processor is further configured to:
control a peripheral direct memory access device to read a data in a memory and to transmit the data to the peripheral device when the number of times that the interrupt pre-processor receives the interrupt signal from the peripheral device is lower than the first predetermined number.

5. The micro-controller system as claimed in claim 4, wherein the peripheral direct memory access device is further configured to:
read the data corresponding to the number of times that the interrupt pre-processor receives the interrupt signal from the peripheral device and the peripheral device; and
transmit the data to the peripheral device.

6. A method for waking up the central processing unit, applicable to a micro-controller system comprising a central processing unit, a peripheral device, and an interrupt pre-processor, wherein the interrupt pre-processor is connected between the central processing unit and the peripheral device, wherein the method comprises:
receiving an interrupt signal from the peripheral device using the interrupt pre-processor when the central processing unit is powered down; and
outputting a wake-up signal to activate the central processing unit using the interrupt pre-processor when a number of times that the interrupt pre-processor receives the interrupt signal from the peripheral device is higher than or equal to a first predetermined number.

7. The method as claimed in claim 6, further comprising:
receiving a temperature information from the peripheral device using the interrupt pre-processor; and
outputting the wake-up signal to activate the central processing unit using the interrupt pre-processor when a number of times that the temperature information is higher than a threshold is higher than or equal to a second predetermined number.

8. The method as claimed in claim 6, wherein the first predetermined number is higher than or equal to 2.

9. The method as claimed in claim 6, further comprising:
controlling a peripheral direct memory access device to read data in a memory and to transmit the data to the peripheral device using the interrupt pre-processor when the number of times that the interrupt pre-processor receives the interrupt signal from the peripheral device is lower than the first predetermined number.

10. The method as claimed in claim 9, further comprising:
reading the data corresponding to the number of times that the interrupt pre-processor receives the interrupt signal from the peripheral device and the peripheral device using the peripheral direct memory access device; and
transmitting the data to the peripheral device.
